(19) United States
(12) Patent Application Publication
(10) Pub. No.: US 2023/0122291 A1
(43) Pub. Date: Apr. 20, 2023

(54) Case Cover for Covering the Back of a Computer Case

(71) Applicant: Jonathan Mohr, Spring, TX (US)

(72) Inventor: Jonathan Mohr, Spring, TX (US)

(21) Appl. No.: 17/504,543

(22) Filed: Oct. 19, 2021

(51) Int. Cl. G06F 1/18

(52) U.S. Cl. CPC G06F 1/181; G06F 1/20

(57) ABSTRACT

A case cover for covering the back of a computer case is disclosed. The case cover can comprise a back panel, a plurality of walls that extend from the back panel, one or more holes within a wall of the plurality of walls, and one or more fasteners on the plurality of walls. The back panel and side walls together form a partial enclosure. One or more cables for connecting to a personal computer are capable of passing through the one or more holes. The cover fasteners are capable of mounting the case cover to the computer case.

### BACKGROUND

This disclosure relates to a case cover for covering the back of a computer case.

With the recent boom of gaming industry and social media platforms, content creators, and social influencers have started prominently displaying their computer cases. Influencers, especially gamers, will usually appear to their audience with their computer case shown in the background. Thus, it is important for them to have a visually-appealing case. The most common setup being used includes a transparent computer case with different LED lights setup within the case. In this setup, the user would usually place their computer case on top of their working area wherein a sidewall of the computer casing is facing them, an audience, or a camera. Such method can be appealing. However, such setup can make the common computer buttons, and computer ports inaccessible. Furthermore, in such setup the cables at the back of the casing can be visible and can cause visual clutter. One of the common methods of organizing cables is through tying the cables together with the use of zip ties or electrical tapes. Such method can be effective in improving the visual clutter but can cause inconvenience during disassembly, repair, or replacement of computer devices. Additionally, tying cables together can block the air flow at the back of the computer. Thus, it can be useful to have case cover for covering the back of the computer case.

### SUMMARY

A case cover for covering the back of a computer case is disclosed. The case cover can comprise a back panel, a plurality of walls that extend from the back panel, one or more holes within a wall of the plurality of walls, and one or more fasteners on the plurality of walls. The back panel and side walls together form a partial enclosure. One or more cables for connecting to a personal computer are capable of passing through the one or more holes. The cover fasteners are capable of mounting the case cover to the computer case.

### BRIEF DESCRIPTION OF THE DRAWINGS

FIG. 1 illustrates an embodiment of a case cover.

FIG. 2A illustrates another embodiment of a case cover comprising an onboard computer.

FIG. 2B illustrates an internal hardware of an onboard computer.

FIG. 3 illustrates an embodiment of a case cover with an onboard computer further comprising one or more input-output (I/O) devices.

FIG. 4 illustrates a closer view of a Universal Serial Bus (USB) hub.

FIG. 5A illustrates another embodiment of a case cover further comprising one or more mounting points.

FIG. 5B illustrates how input-output devices can be connected to an onboard computer.

FIG. 5C illustrates a closer view on how an input-output device can be attached to a mounting point.

FIG. 6 illustrates how a case cover can attach to a computer case.

FIG. 7 illustrates a case cover attached to a computer case through cover fasteners.

FIG. 8 illustrates another embodiment of cover fasteners comprising a magnet.

FIG. 9 illustrates an embodiment of a case cover further comprising a coolant reservoir mount.

### DETAILED DESCRIPTION

Described herein is a case cover for covering a back of a computer case. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

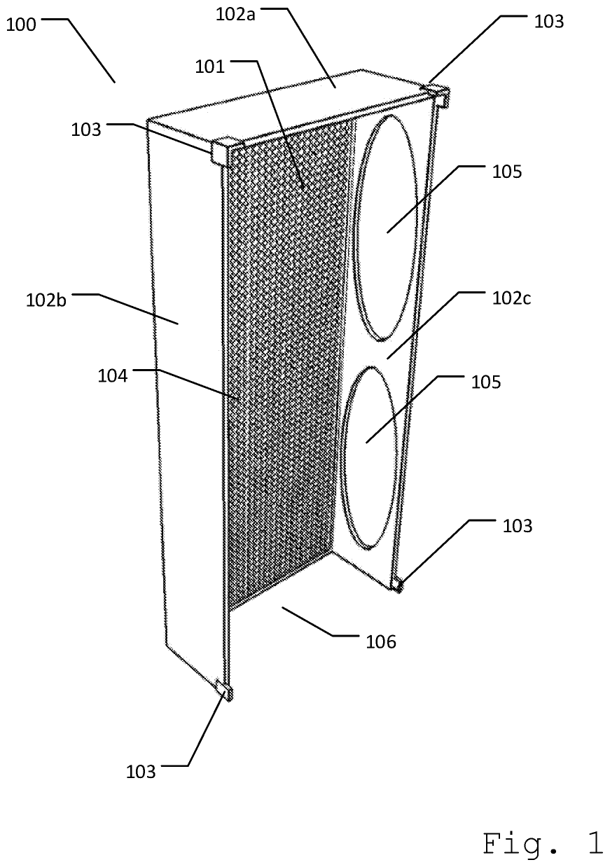

FIG. 1 illustrates an embodiment of a case cover 100. Case cover 100 can be used to manage the cables at the back of a computer case. Case cover 100 can route cables from the back of computer case into a preferred direction. In one embodiment, case cover 100 can comprise a back panel 101, a plurality of walls 102, and one or more cover fasteners 103. In such embodiment, back panel 101 can be the surface that is placed in front of the back surface of the computer case. Walls 102 can extend outward the side edges of back panel 101, which encloses the sides of case cover 100. In one embodiment, walls 102 can extend from the top edge and side edges of back panel 101, thus creating a bottom opening 106. As such, walls 102 can comprise a top wall 102a, a first sidewall 102b, and a second sidewall 102c. In one embodiment, back panel 101 can comprise a plurality of uniformly distributed perforations 104, which can allow proper airflow at the back of the computer. Moreover, such design can conceal the visual clutter caused by the cables attached at the rear of the computer case. cover fasteners 103 can be an extended portion of case cover 100, which can secure case cover 100 to the computer case. In one embodiment, cover fasteners 103 can be placed on each edge corner of walls 102.

Further in one embodiment, case cover 100 can comprise one or more holes 105 on one of sidewalls 102. Each hole 105 can be a through and through hole that is large enough to allow cables to pass through. In this embodiment, the cables at the back of the computer can be routed to holes 105 on one of the walls 102 or to bottom opening 106. In another embodiment, each wall 102 a plurality of walls 102 can comprise holes 105. As such, cables can be routed through various walls 102 of case cover 100 and through bottom opening 106.

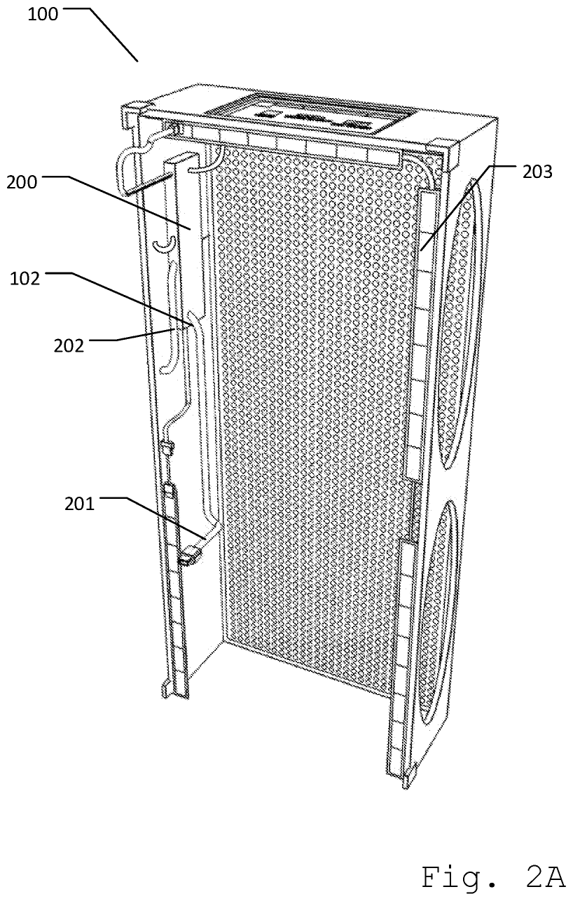

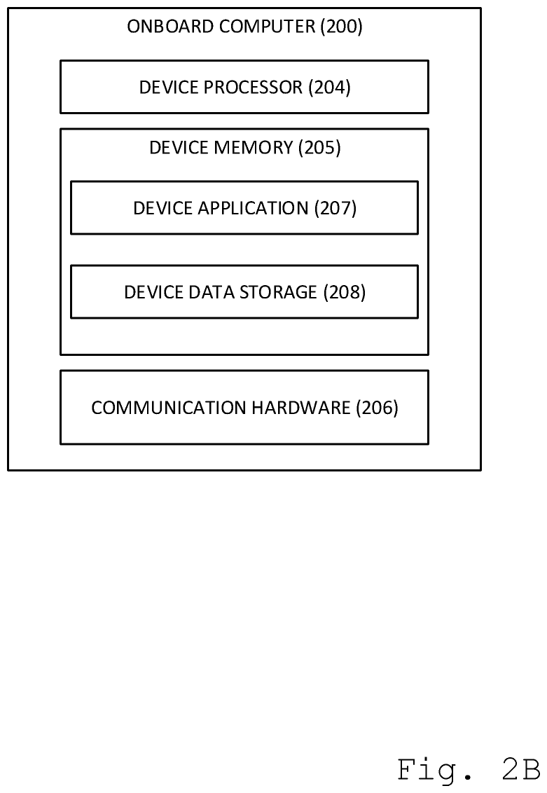

FIG. 2A illustrates another embodiment of case cover 100 comprising an onboard computer 200. Onboard computer 200 can be mounted within the inner surface of one of walls. Onboard computer 200 can be a computing device capable of storing and processing data. As such, onboard computer 200 can be connectable with the computer within the compute casing to allow communication between devices. This can allow a user to control input and output (I/O) devices that are connected to onboard computer 200 using the computer. In one embodiment, onboard computer 200 can comprise one or more main connectors 201, and one or more input/output (I/O) connectors 202. In one embodiment, main connector 201 can connect onboard computer 201 to the computer. As such, the personal computer can provide power to onboard computer 200 as well as any IO devices. I/O connectors 202 can connect onboard computer 201 to I/O devices. In one embodiment, case cover 100 can further comprise a light-emitting diode (LED) strip 203. In one embodiment, LED strip 203 can be mounted within case cover 200. In such embodiment, case cover 100 can be made of translucent or transparent material.

FIG. 2B illustrates exemplary internal hardware of onboard computer 200 comprising a device processor 204, a device memory 205, and communication hardware 206. Device processor 204 can be a device that executes programs stored in device memory 205. Device memory 205 can be a physical device used to store programs and data. Communication hardware 206 can be any hardware known in the art for facilitating communication between devices or a network.

Device memory 205 can comprise comprising a device application 207 and a device data storage 208. Device application 207 can reside and perform logical functions within device memory 205. Device application 207 can receive and transmit sets of instructions and data information from the computer or from input devices of I/O devices. Device data storage 208 can be a component in device memory 205 that can be used to retain digital data. Further, device processor 204 can perform processes on the data according to device application 207 stored in device memory 205. Processes can include storing input data in device data storage 208.

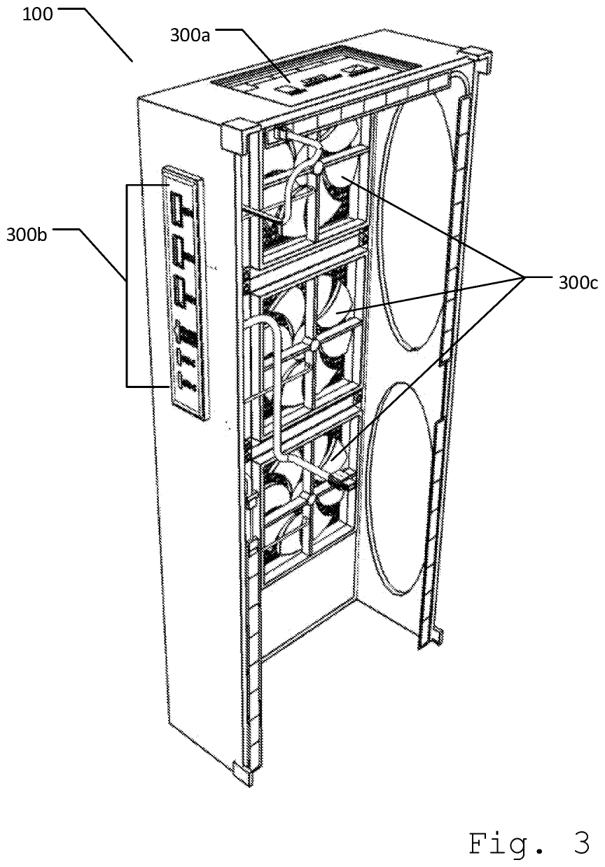

FIG. 3 illustrates an embodiment of case cover 100 with onboard computer 200 connected to one or more input-output (I/O) devices 300. I/O devices 300 can be any hardware device that are capable of delivering and receiving data from the computer Some examples of I/O device 300 can include but are not limited to a screen display, keyboard, trackpad, scanner (such as biometric), card reader, ports, lights, and a fan. As an exemplary embodiment, I/O devices 300 can comprise one or more screens 300a, one or more USB hubs 300b, and one or more fans 300c. Screen 300a can be a mere display output, or can also be a touch screen, allowing for capturing of input data at case cover 100 and sending the input data to onboard computer 200 and/or personal computer. In one embodiment, USB hub 300b can comprise of USB ports or USB-C ports, and it can also include card readers. In one embodiment, USB hub can connect directly to the personal computer rather than connecting to an onboard computer 200. Further, in one embodiment, onboard computer and USB hub can be unitary. Having USB hub 300b on case cover 100 can allow accessibility to the USB connections that are commonly placed at the back of the personal computer. In one embodiment, I/O devices 300 can be permanently mounted on case cover 100. In an example embodiment, screens 300a can be placed on top wall 102a and can be connected to onboard computer 200 through I/O connector 202. As such, screen 301 can be visible and accessible to a user while USB hub 302 can be placed on one of sidewalls 102 and can be connected to onboard computer 201 through another I/O connector 202. In this embodiment, fans 303 can be attached on back panel 101. Attaching one or more fans 303 to back panel 101 can allow better airflow at the back of the computer case and can prevent the personal computer from overheating. Fans 303 can also be connected to onboard computer 200 through another I/O connector 202c. Further in another embodiment, I/O devices 300 can be interchangeably attached to case cover 100, which can be further discussed below.

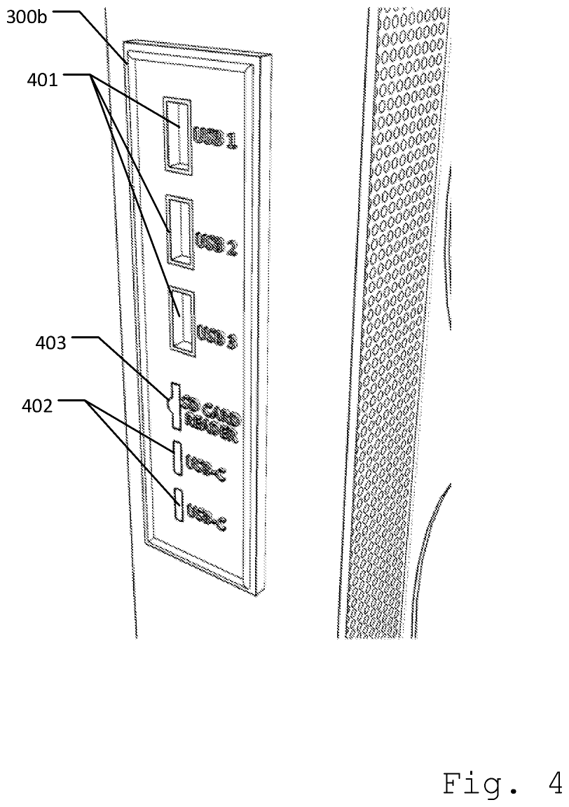

FIG. 4 illustrates a closer view of hub USB 300b comprising one or more USB ports 401, one or more USB Type-C (USB-C) ports 402, and one or more card readers 403. In this embodiment, USB hub 302 can allow standard ports and readers be accessible to the user. In one embodiment, USB hub 302 can also comprise of LED lights to improve visual appearance.

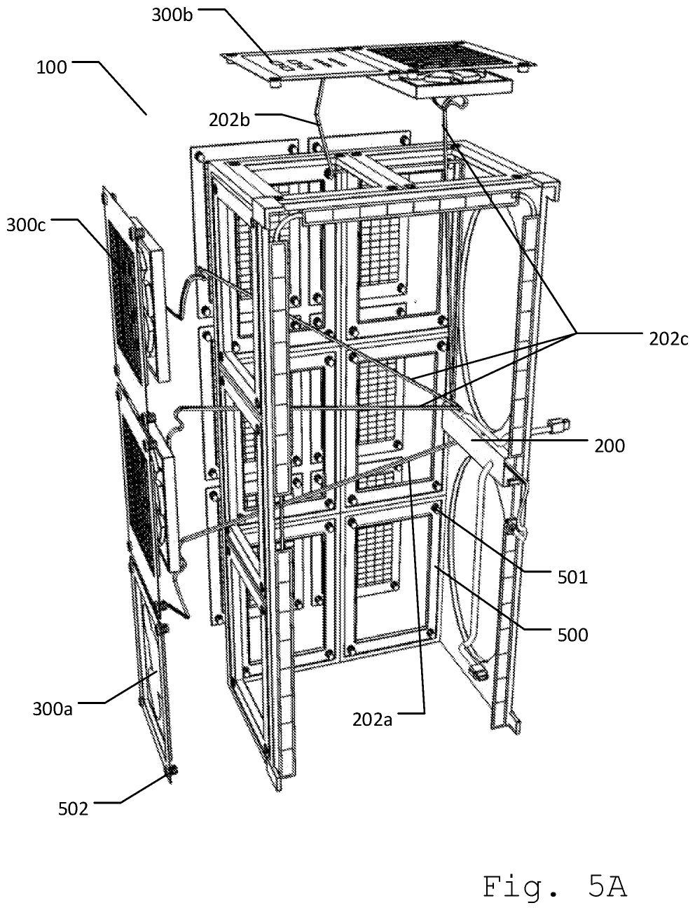

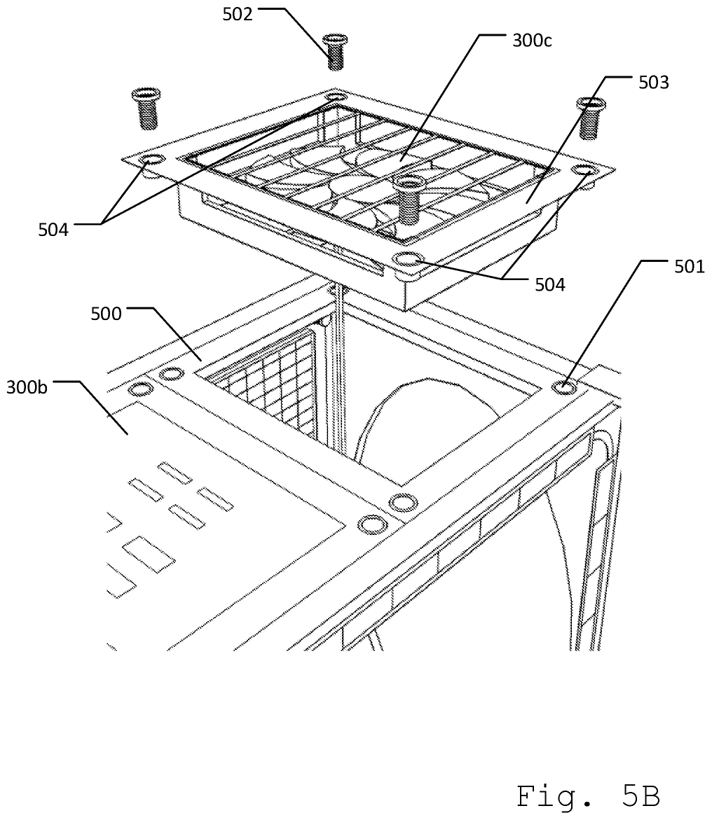

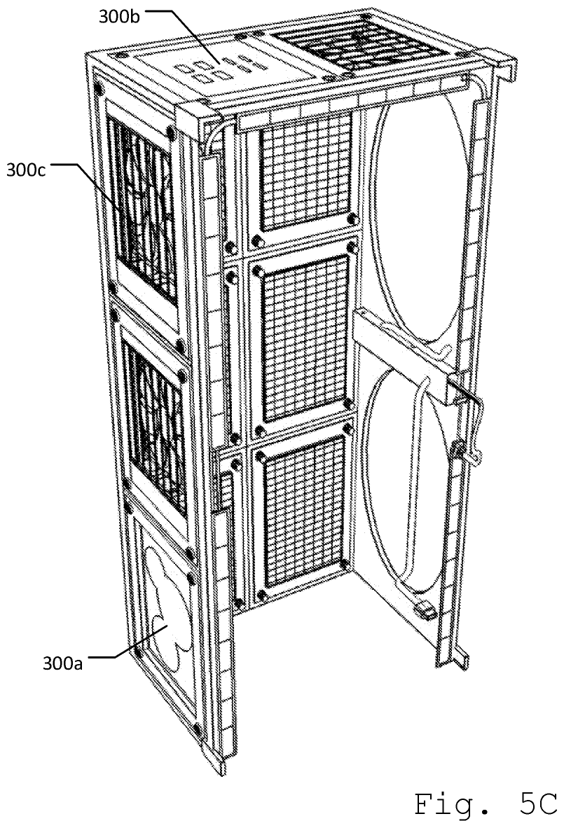

FIG. 5A illustrates another embodiment of case cover 100 further comprising one or more slots 500. Each slots 500 can be a framed portion on case cover 100 to which each I/O device 300 can be mounted. In one embodiment, each slot 500 can comprise one or more fastening mates 501 mateable with a fastener 502. Some examples of fastener 502 include, but are not limited to, screws, clips, or hook/loop of hook and loop. Similarly, fastening mate could be a threaded orifice, clip receiving orifice with a catch, or hook/loop of hook and loop. In one embodiment, there can exist multiple slots 500 to allow a user to customize the placement of each I/O device 300 on case cover 100.

In one embodiment, screen 300a can connect to onboard computer 200 through a first I/O connector 202a, while USB hub 300b can connect to onboard computer 200 through a second I/O connector 202b. Lastly, fan 300c can connect to onboard computer 200 through one or more third I/O connectors 202c. In another embodiment, one or more I/O devices 300 can be unitary with onboard computer 200.

FIG. 5B illustrates a closer view on how an input-output device 300 can be attached to slot 500. In one embodiment, each I/O device 300 can be housed in a body 503 compatible with slot 500. In such embodiment, I/O device 300 can comprise fasteners 502 to mount I/O device 300 at slot 500. In one embodiment, orifice 504 Orifice 504 can be a hole placed on each corner of body 503. Once orifices 504 and slots 501 are aligned, fasteners 502 can be inserted through the holes to fasten I/O device to case cover 100.

FIG. 5C illustrates I/O devices 300 attached to case cover 100.

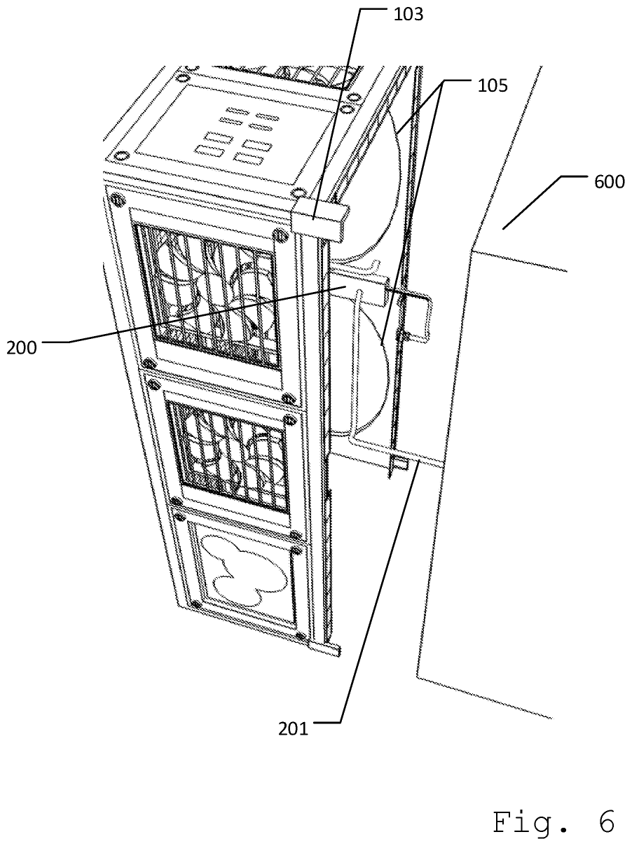

FIG. 6 illustrates how case cover 100 can attach to a personal computer 600. In a first embodiment wherein case cover 100 does not comprise onboard computer 201, the cables at the back of personal computer can first be routed within holes 105 before covering the back of personal computer 600 with case cover 100. Once cables are placed within holes 105, case cover 100 can be attached to the back of CPU through cover fasteners 103, as further shown and discussed below. In this embodiment, case cover 100 can be used to manage the cable system at the back of personal computer 600.

In another embodiment wherein case cover 100 can comprise onboard computer 201, USB cable 201 from onboard computer 201 can first be connected to the USB port on personal computer 600. As such, personal computer 600 can provide power to onboard computer 201. In such embodiment, case cover 100 can be used to provide display control, and manage input and output devices attached to onboard computer 201 and personal computer 600. As an example, LED lights 204 on case cover 100 can be controlled. Examples of control including causing LED lights 204 to go on and off in a pattern, change as a function of music that is playing, or change colors either automatically or manually. Further in one embodiment, device application 207 can be installed to personal computer 600, which can facilitate control over I/O devices 300.

In another embodiment wherein I/O devices 300 can be placed interchangeably within case cover 100, the user can first attach each I/O device 300 on a desired area. Once attached, I/O connectors 202 of each I/O device 300 can be connected to onboard computer 201.

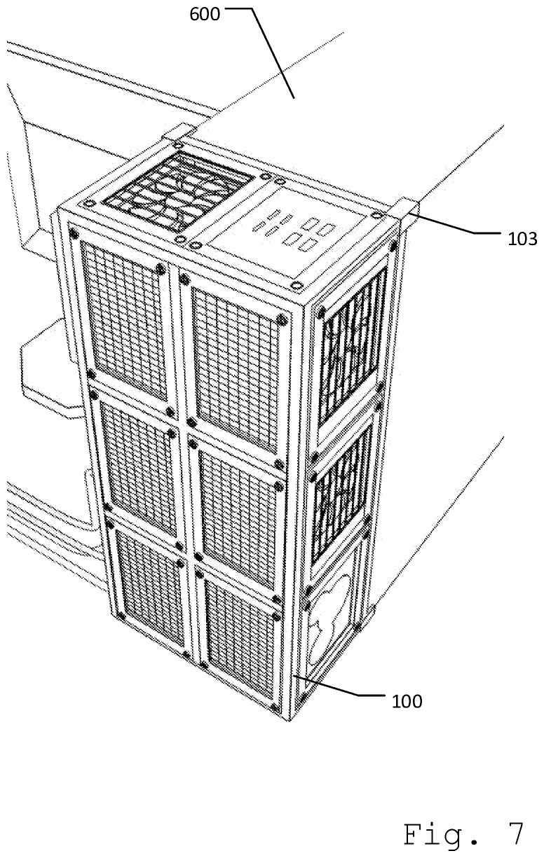

FIG. 7 illustrates case cover 100 attached to personal computer 600 through cover fasteners 103. In one embodiment, cover fasteners 103 can be a guide that connects back cover 100 to the personal computer case. In this embodiment, cover fastener 103 can be placed at the corners of walls 102. Cover fastener 103 can fit snugly with the corners of personal computer case.

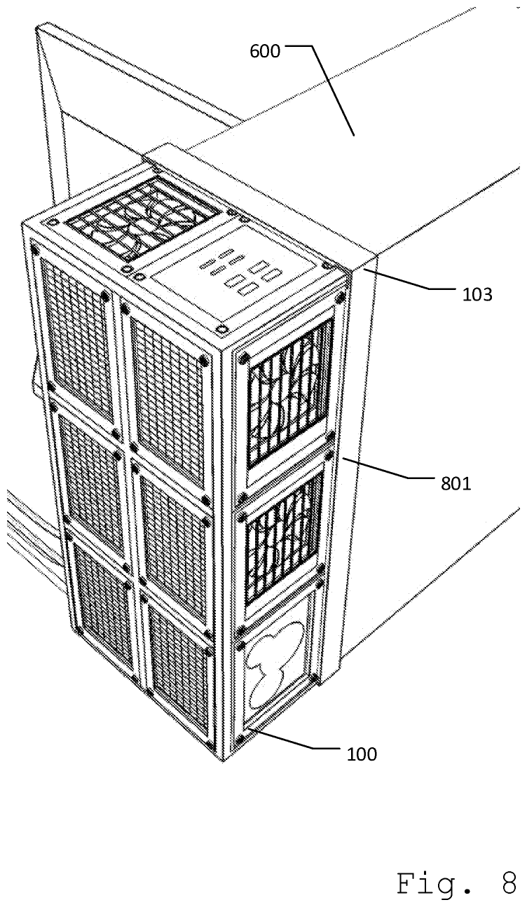

FIG. 8 illustrates another embodiment of cover fasteners 103 comprising a magnet 801. In this embodiment, cover fasteners 103 can extend around the edge of side panels 102 and top panel 105. In such embodiment, cover fasteners 103 can run through the all or portions border of the personal computer tower. Magnet 801 can securely connect case cover 100 to the back of personal computer 600.

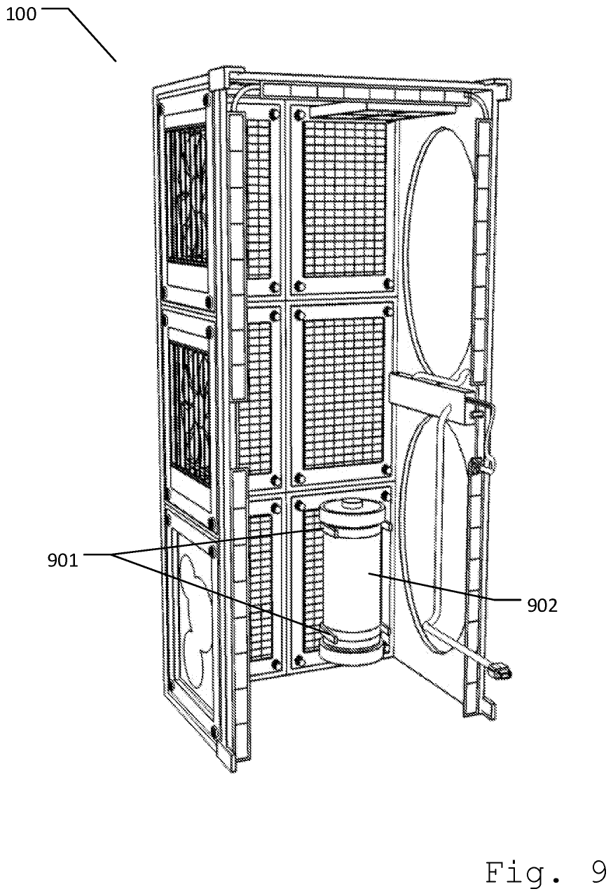

FIG. 9 illustrates an embodiment of case cover 100 further comprising a coolant reservoir mount 901. This can allow user to readily attach a computer coolant reservoir 902 to coolant reservoir mount 901. In another embodiment, case cover 100 can comprise coolant reservoir 902.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A case cover for covering the back of a computer case, the case cover comprising
a back panel;
a plurality of walls that extend from said back panel bordering the sides of said case cover, said plurality of walls and said back panel together forming a partial enclosure;
one or more holes within a wall of said of said plurality of walls, wherein one or more cables for connecting to a personal computer are capable of passing through the one or more holes; and
one or more cover fasteners on said plurality of walls, wherein said cover fasteners are capable of mounting the case cover to the computer case.

2. The case cover of claim 1 wherein said plurality of walls comprises a top wall, a first side wall, and a second side wall.

3. The case cover of claim 1 wherein said back panel, said first side wall, and said second side wall together form a bottom opening, wherein the one or more cables are capable of passing through the bottom opening.

4. The case cover of claim 1 further comprising an onboard computer connectable to a personal computer having the computer case, said onboard computer capable of receiving power from the personal computer.

5. The case cover of claim 4 further comprising one or more input/output (I/O) devices controllable by said onboard computer.

6. The case cover of claim 5 wherein a first I/O device of said one or more I/O devices is mounted within a slot of the case cover.

7. The case cover of claim 6 wherein said slot is within a second wall of said plurality of walls.

8. The case cover of claim 6 wherein said slot is with said back panel.

9. The case cover of claim 6 wherein said first I/O device is removeable and replaceable with a second I/O device.

10. The case cover of claim 5 wherein said first I/O device is a screen.

11. The case cover of claim 5 wherein said screen is a touchscreen.

12. The case cover of claim 5 wherein said first I/O device is a fan.

13. The case cover of claim 5 wherein said first I/O device is a USB hub.

14. The case cover of claim 4 wherein a first I/O device of said one or more I/O devices is a light set.

15. The case cover of claim 8 wherein a cover fastener of said cover fasteners comprises a magnet.

16. The case cover of claim 1 further comprising one or I/O devices capable of interfacing with the personal computer.

17. The case cover of claim 1 further comprising a coolant reservoir mount capable of supporting a computer coolant reservoir.
